(19) United States
(12) Patent Application Publication
(10) Pub. No.: US 2020/0394111 A1
(43) Pub. Date: Dec. 17, 2020

(54) Method for Operating a Redundant Automation System

(71) Applicant: Siemens Aktiengesellschaft, Muenchen (DE)

(72) Inventors: Thomas Grosch, Rosstal (DE); Albert Renschler, Ettlingen (DE); Jürgen Laforsch, Buhl (DE)

(21) Appl. No.: 16/894,962

(22) Filed: Jun. 8, 2020

(30) Foreign Application Priority Data
Jun. 11, 2019 (EP) 19179346

(51) Int. Cl. G06F 11/16; G05B 9/03; G05B 19/042

(52) U.S. Cl. CPC G06F 11/1687; G05B 9/03; G05B 2219/24187; G05B 2219/24186; G05B 19/0428

(57) ABSTRACT

A method for operating a redundantly configured automation system which has a first subsystem and a second subsystem, wherein one of these subsystems operates as the master and the other of these subsystems operates as the slave, where in the event that the master fails the slave takes over the function of the master, and where the first subsystem receives a data packet generated by an external data source and forwards the data packet only at a level of the physical layer and the data link layer to the second subsystem before processing of the data packet occurs in the first subsystem at a higher layer than the level of the physical layer and the data link layer.

### BACKGROUND OF THE INVENTION

### 1. Field of the Invention

The invention relates to redundantly configured automation systems and methods for operating a redundant automation system which has a first subsystem and a second subsystem, where one of these subsystems operates as a master and the other subsystem operates as a slave, where in the event that the master fails the slave assumes the functions of the master.

### 2. Description of the Related Art

High-availability solutions (H systems) that are suited to reducing any potentially occurring downtimes of the system to a minimum are becoming increasingly required in automation environments. The development of such high-availability solutions is very cost-intensive, where an H system usually used in the automation environment is characterized by two or more subsystems being coupled together in the form of automation devices or computer systems via a synchronization link. In principle, both subsystems can have read and/or write access to the peripheral units connected to this H system. One of the two subsystems is the lead with respect to the peripherals connected to the system. This means that outputs to the peripheral units or output information for these peripheral units are only performed by one of the two subsystems, i.e., by the one that operates as the master or has assumed the master function. Both systems are synchronized at regular intervals via a synchronization link such that both systems can run synchronously. With respect to the frequency and scope of the synchronization, a distinction can be made between various characteristics (warm-standby, hot-standby).

A redundant automation system made up of two subsystems, which is provided to increase the availability of a system to be controlled, is known from the Siemens catalog ST70, chapter 6, 2011 edition. This automation system is regularly synchronized and ensure that the failure of one of these subsystems does not have a negative impact on a process to be controlled, because the other subsystem can continue with the execution or processing of the corresponding part of its respective control program or the execution or processing of the corresponding parts of this control program.

EP0 907 912 B1 discloses a synchronization method for an automation system made up of two subsystems. This synchronization method is based on a temporally synchronous coupling of both subsystems, where both subsystems wait for an answer from the respective other participant at suitable program positions at which a comparison is provided, and only then does each continue with their temporally synchronous program processing.

EP 2 657 797 A1 discloses a method for operating a redundant automation system, which includes a particularly advantageous synchronization method.

In the case of redundant automation systems, the fundamental problem lies in processing incoming as well as outgoing data streams in a synchronized manner. This essentially means that incoming data streams must be duplicated on both redundant subsystems and outgoing data streams that occur in both redundant subsystems have to be separated. In the case of conventional redundancy solutions, this is associated with a correspondingly high computing time load on the two subsystems.

### SUMMARY OF THE INVENTION

In view of the foregoing, it is therefore an object of the invention to provide a method methods for operating a redundant automation system which has a first subsystem and a second subsystem, via which a load on the subsystems of a redundantly configured automation system can be reduced.

This and other objects and advantages are achieved in accordance with the invention by a method in which the first subsystem receives a data packet generated by an external data source and forwards the data packet at a level of the physical layer and/or the data link layer to the second subsystem before processing of the data packet occurs in the first subsystem at a level of a layer that is higher than the level of the physical layer and/or the data link layer. The first subsystem operates here as the slave, i.e., it runs after the second subsystem, which operates as the master, with respect to processing the data packet.

The advantages of the invention lie in an improved performance of the two subsystems of the automation system because required synchronizations between the two subsystems to achieve the redundancy already occurs at a level of the physical layer and/or the data link layer. The data packet received from the external data source must thereby move through higher levels of layers, such as the network layer or the transport layer, before the data packet is transferred from the first subsystem to the second subsystem. The use of the method in accordance with the present invention increases the performance capability of redundant automation solutions, which opens up new additional possible applications.

In an advantageous embodiment of the invention, the first subsystem stores the data packet in the context of processing the data packet in an electronic memory of the first subsystem, preferably a First-in-First-out (FIFO) memory. The memory is configured to save the data packet in a particular sequence and to re-output the data packet in the particular sequence.

Should the second subsystem fail, the first subsystem must continue processing the applications seamlessly. To this end, the first subsystem can access the data stored in the memory.

Once the data packet has been stored in the memory of the first subsystem, a synchronization message is preferably transmitted from the second subsystem to the first subsystem in order to synchronize processing of the data packet on the second subsystem with processing of the data packet on the first subsystem.

The synchronization message particularly and preferably includes information with respect to which quantity of data from the data packet stored in the memory of the first system the first subsystem should remove from the memory. With this approach, it is not necessary to transfer the entire (possibly large) quantity of data in the data packet for the purposes of synchronization from the second subsystem to the first subsystem, but only information as to which quantity of data the first subsystem should remove from the memory.

It is also an object of the invention to provide a redundantly configured automation system that has a first subsystem and a second subsystem, where one of these subsystems is configured to operate as the master and the other subsystem is configured to operate as the slave, and where the slave is configured such that in the event that the master fails the slave assumes the functions of the master. In accordance with the invention, the first subsystem of the redundantly configured automation system is configured to receive a data packet generated by an external data source and to forward the data packet at the level of the physical layer and/or the data link layer to the second subsystem before processing of the data packet occurs in the first subsystem at a higher layer than the level of the physical layer and/or the data link layer.

In an alternative embodiment of the method in accordance with the invention, a data packet intended for an external recipient is transferred from the second subsystem to the first subsystem at the level of the physical Layer and/or the data link layer and the data packet is forwarded from the first subsystem to the external recipient before processing of the data packet occurs in the first subsystem at a higher layer than the level of the physical layer and/or the data link layer.

In an analogous manner to the previously explained embodiment of the method in accordance with the invention, the presently contemplated embodiment has the advantage that only a level of the physical layer and/or the data link layer is passed through before the data transfer occurs between the first subsystem and the second subsystem (in this case in the context of sending a data packet to an external recipient).

It is also an object of the invention to provide a redundantly configured automation system in accordance with an alternative embodiment of the invention. Here, the second subsystem is configured to transfer a data packet intended for an external recipient from the second subsystem to the first subsystem at the level of the physical layer and/or the data link layer and the first subsystem is configured to forward the data packet received from the second subsystem to the external recipient before processing of the data packet occurs in the first subsystem at the higher layer than the level of the physical layer and/or the data link layer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will become clearer and more intelligible in conjunction with the following description of the exemplary embodiment which will be explained in detail making reference to the drawings, in which:

FIG. 1 shows an automation system with two subsystems in accordance with the invention;

FIG. 2 shows a sequence of a temporal coupling of two subsystems in the case of an incoming data packet in accordance with the invention;

FIG. 3 shows the sequence of FIG. 1 in the event of a failure of one of the two subsystems;

FIG. 4 shows a sequence of a temporal coupling of two subsystems in the case of an outgoing data packet in accordance with the invention; and

FIG. 5 is flowchart of the method in accordance with the invention.

### DETAILED DESCRIPTION OF THE EXEMPLARY EMBODIMENTS

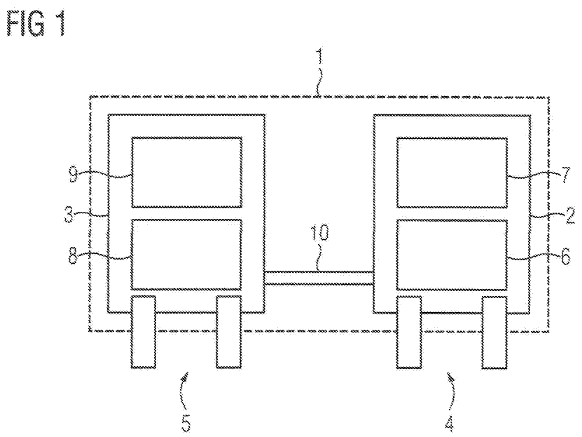

FIG. 1 shows an automation system 1 configured as a redundant network node. The automation system 1 includes a first subsystem 2 and a second subsystem 3. The first subsystem has a first network interface 4, the second subsystem a second network interface 5, via which the two subsystems 2, 3 can communicate with external devices (not shown).

The first subsystem 2 can be divided internally into a first transport system 6 and a first application system 7, whereas in an analogous manner the second subsystem 3 has a second transport system 8 and a second application system 9. The first transport system 6 and the second transport system take on tasks of forwarding or transferring data packets inter alia between the two subsystems 2, 3. To this end, the two subsystems 2, 3 are coupled together via a synchronization link 10.

It should be understood that the second subsystem 3 is assumed to be operated as the master and the first subsystem 2 is assumed to be operated as the slave or as the reserve. With respect to control of a technical process, the master assumes the lead and is responsible for the process control. The slave then only assumes the master function if the master fails as a result of a malfunction.

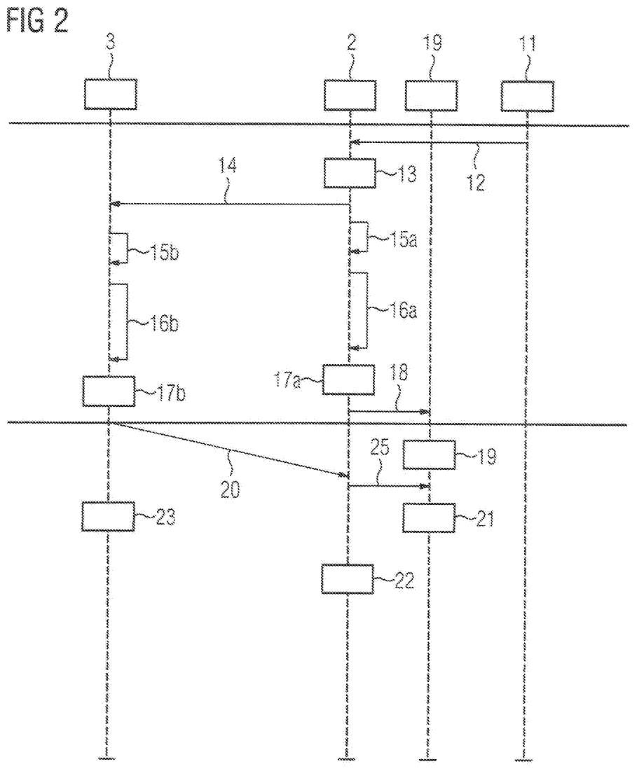

FIG. 2 shows a sequence diagram in the event of a sequence for synchronizing two redundantly configured subsystems 2, 3. Here, a data packet generated from an external data source 11 is received by the first subsystem 2 in a first step 12. Initially, the first subsystem 2 now performs an analysis 13 of the data packet and determines, among other things, the type of data packet and the destination addresses included in the data packet. Here, a check is performed, for example, in order to ascertain whether an IP address included in the data packet as a destination address corresponds to an IP address of the automation system 1. This check is performed on behalf of the second subsystem 3 by the first subsystem 2.

Once the address has been successfully checked, a transfer 14 of the data packet from the first subsystem 2 to the second subsystem 3 occurs at a level of the physical layer and/or the data link layer. This transfer 14 already occurs before the data packet is further processed by the first subsystem 2 at a level of a higher layer (network layer, transport layer etc.) of the transport system 6 of the first subsystem 2.

An interim buffering 15a, 15b of the data packet and a further processing 16a, 16b at a level of a higher layer (network layer, transport layer etc.) of the respective transport system 6, 8 of the two subsystems 2, 3 then occurs on both subsystems 2, 3. The part of the data packet relevant to the respective application system 7, 9, the “application data” 17a, 17b, is taken from the data packet by applications, such as web servers on both of the subsystems 2, 3. In this way, no data processing occurs as yet, but only a separation of the application data 17a, 17b from the remaining part of the data packet.

The application data 17a is stored in the first subsystem 2 as part of a storage process 18 in a memory 19 configured as a FIFO memory (First In—First Out). This is configured to store the application data 17a in a specific sequence.

Once the application data 17a has been stored in the memory 19 of the first subsystem 2, a synchronization message 20 is transmitted from the second subsystem 3 to the first subsystem 2. In this context, the synchronization message includes information as to which quantity of application data 17a is to be removed from the memory 19 of the first subsystem 2. The sequence of the actual synchronization occurs as described in EP 2 657 797 A1. Full reference should be made in this context to this publication.

The synchronization message 20 triggers a removal instruction 25 that is addressed directly to the memory 19. Following the removal 21 of the application data 17a from the FIFO memory 19, the application data 17a is subject to processing 22 on the first subsystem 2 by an application (e.g., a web server). An analogous processing 23 of the application data 17b located there occurs on the second subsystem 3.

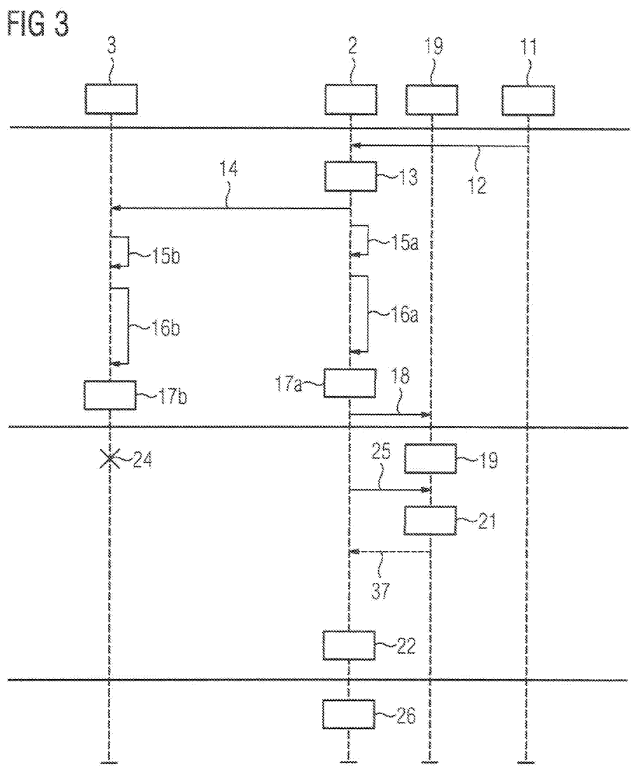

FIG. 3 essentially shows the same sequence diagram as shown in FIG. 2. One difference here, however, lies in the fact that after running through the higher levels of layers or separating the application data 17a, 17b from the remaining part of the data packet, failure 24 of the second subsystem 3 (functioning as the master) occurs. The first subsystem 2 (functioning as the slave) must now assume the tasks of the master system 3 and, for example, maintain the operation of a process installation. In this context, it should be possible for data transfer to external devices to be continued without any data loss.

Should the second subsystem 3 fail, the first subsystem 2 must seamlessly continue processing at the level of the applications. This is possible because the first subsystem 2 following a removal instruction 25 automatically generated at a specific point in time removes the application data 17a included in the FIFO memory 19 and forwards this application data 17a as part of a forwarding 37 to the application processing 22 of the first subsystem 2 until the FIFO memory 19 is emptied. The status of the first subsystem 2 is then identical to that of the second subsystem 3 at the time of the failure 24. Once the FIFO memory 19 has been emptied, the application on the first subsystem 1 once again reads directly from the level of the further processing 16a, 16b at a level of a higher layer (e.g., network layer or transport layer) of the transport system 6 of the first subsystem 2 (also known as a “layer stack”). A link 26 to a communication partner can therefore be continued without interruption and without data loss because the status of the layer stack 16a on the first subsystem 2 has not been changed since the failure 24.

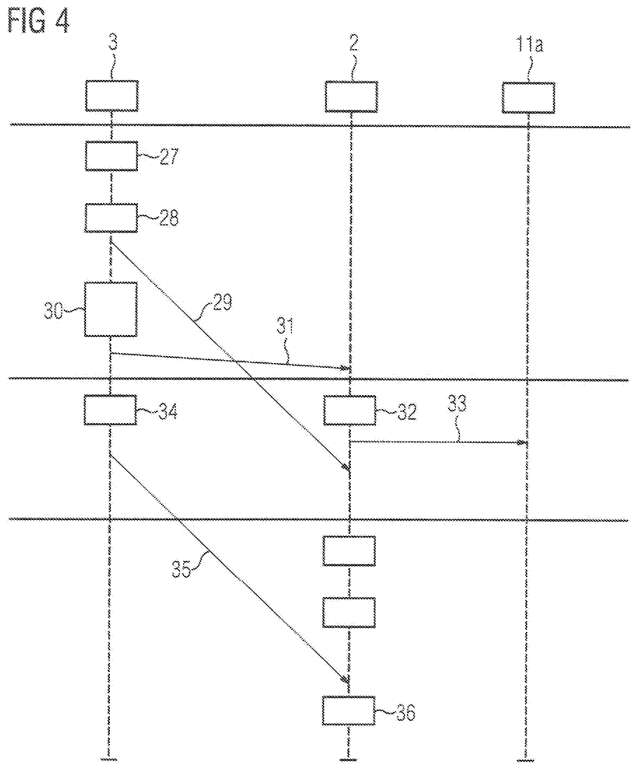

FIG. 4 shows a sequence diagram for sending data packets. The starting point is the application data 27 processed by an application on the second subsystem 3. Resulting from a send request 28 from the second subsystem 3 addressed to the transport system 8, a first synchronization message 29 is transmitted to the first subsystem 2. The sequence of the actual synchronization occurs as described in EP 2 657 797 A1. As a result, a discard 30 of the application data 27 on the second subsystem 3 and a data transfer 31 of the application data 27 to the first subsystem 2 occur. On the first subsystem 2 a send instruction 32 is connected to the transport system 6 of the first subsystem 2, and is followed by a transfer 33 of the application data 27 to an external recipient 11 a. The data transfer 31 between the second subsystem 3 and the first subsystem 2 already occurs, in this case, at the level of a physical layer and/or a data link layer, whereby the method is particularly efficiently configured.

In parallel to this, processing 34 of further (new) application data occurs on the second subsystem 3. With a second synchronization message 35, information relating thereto, as described in EP 2 657 797 A1, is exchanged with the first subsystem 2. An analogous further processing 36 of the new application data occurs there.

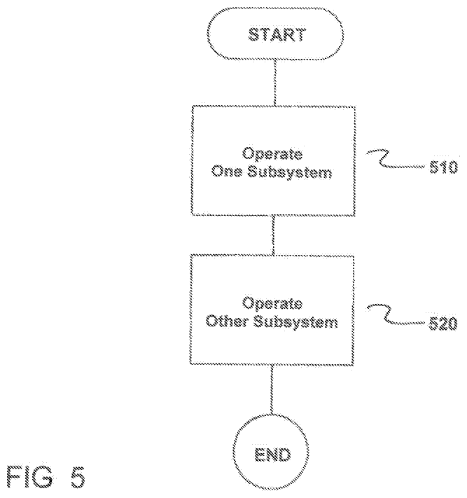

FIG. 5 is a flowchart of the method for operating a redundantly configured automation system 1 having a first subsystem 2 and a second subsystem 3. The method comprises operating one subsystem of the first and second subsystems 2, 3 as a master, as indicated in step 510. Next, the other of the first and second subsystems 2, 3 is operated as a slave which, in an event that the master fails, assumes functionalities of the master, as indicated in step 520. In one embodiment, the first subsystem 2 receives a data packet generated by an external data source 11 and forwards the data packet only at a level of the physical layer and the data link layer to the second subsystem 3 before processing of the data packet occurs in the first subsystem 2 at a higher layer than the level of the physical layer and the data link layer. In an alternative embodiment, a data packet intended for an external recipient 11a is transferred from the second subsystem 3 to the first subsystem 2 only at a level of the physical layer and the data link layer and the data packet is forwarded from the first subsystem 2 to the external recipient 11a before processing of the data packet occurs in the first subsystem 2 at a higher layer than the level of the physical layer and the data link layer.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a redundantly configured automation system having a first subsystem and a second subsystem, the method comprising:
operating one subsystem of the first and second subsystems as a master; and
operating another of the first and second subsystems as a slave which, in an event that the master fails, assumes functionalities of the master;
wherein the first subsystem receives a data packet generated by an external data source and forwards the data packet only at a level of a physical layer and a data link layer to the second subsystem before processing of the data packet occurs in the first subsystem at a higher layer than the level of the physical layer and the data link layer.

2. The method as claimed in claim 1, wherein the first subsystem stores the data packet after the processing at a level of a network layer and at a level of a transport layer in an electronic memory of the first subsystem.

3. The method as claimed in claim 1, wherein the electronic memory comprising a First-in-First-Out memory which is configured to save the data packet in a particular sequence and to re-output the data packet in the particular sequence.

4. The method as claimed in claim 2, wherein once the data packet has been stored in the memory of the first subsystem, a synchronization message is transmitted from the second subsystem to the first subsystem to synchronize processing of the data packet on the second subsystem with processing of the data packet on the first subsystem.

5. The method as claimed in claim 4, wherein the synchronization message includes information as to which quantity of data from the data packet stored in the memory of the first subsystem the first subsystem should be removed from the memory.

6. A redundantly configured automation system comprising:
a first subsystem; and
a second subsystem;
wherein one subsystem of the first and second subsystems is configured to operate as a master and another subsystem of the first and second subsystems is configured to operate as a slave which is configured such that, in an event that the master fails, assumes functionalities of the master; and
wherein the first subsystem is configured to receive a data packet generated by an external data source and to forward the data packet only at a level of a physical layer and a data link layer to the second subsystem before processing of the data packet occurs in the first subsystem at a higher layer than the level of the physical layer and the data link layer.

7. A method for operating a redundantly configured automation system having a first subsystem and a second subsystem, the method comprising:
operating one subsystem of first and second subsystems as a master; and
operating another subsystem of the first and second subsystems operates as the slave which, in an event that the master fails, assumes functionalities of the master;
wherein a data packet intended for an external recipient is transferred from the second subsystem to the first subsystem only at a level of a physical layer and a data link layer and the data packet is forwarded from the first subsystem to the external recipient before processing of the data packet occurs in the first subsystem at a higher layer than the level of the physical layer and the data link layer.

8. A redundantly configured automation system comprising:
a first subsystem; and
a second subsystem;
wherein one subsystem the first and second subsystems is configured to operate as a master and another subsystem of the first and second subsystems is configured to operate as a slave which is configured such that in an event that the master fails the slave assumes functionalities of the master;
wherein the second subsystem is configured to transfer a data packet intended for an external recipient from the second subsystem to the first subsystem only at a level of a physical layer and a data link layer and the first subsystem is configured to forward the data packet received from the second subsystem to the external recipient before processing of the data packet occurs in the first subsystem at a higher layer than the level of the physical layer and the data link layer.
